(19) United States
(12) Patent Application Publication
(10) Pub. No.: US 2009/0174371 A1
(43) Pub. Date: Jul. 9, 2009

(54) CHARGING CONTROL DEVICE FOR VEHICLE USE

(76) Inventor: Chin-Hung Chen, Tainan Hsien (TW)

Correspondence Address: LADAS & PARRY, 5670 WILSHIRE BOULEVARD, SUITE 2100, LOS ANGELES, CA, 90036-5679, US

(21) Appl. No.: 11/970,129

(22) Filed: Jan. 7, 2008

(51) Int. Cl. H02J 7/14

(52) U.S. Cl. 320/163; 322/8

(57) ABSTRACT

A charging control device includes a control unit and a switching circuit. The control unit has an input end connected to a vehicle battery for receiving a battery voltage signal therefrom. The switching circuit includes at least two switch units, each of which is connected between an alternator and the vehicle battery and includes a conducting unit. The conducting unit includes a silicon controlled rectifier (SCR) connected to the control unit and the alternator. The control unit controls the SCR of each switch unit to switch from a non-conducting state to a conducting state with reference to the battery voltage signal such that each switch unit permits supply of electricity from the alternator to the vehicle battery when the battery voltage signal is lower than a predetermined threshold, and interrupts supply of the electricity from the alternator to the vehicle battery when otherwise.

### BACKGROUND OF THE INVENTION

1. Field of the Invention

The invention relates to a charging control device, more particularly to a charging control device for vehicle use.

2. Description of the Related Art

A motor vehicle is usually equipped with a battery to supply electric power to an electrical load of the vehicle. When a motor vehicle is actuated, an engine thereof drives an alternator to generate electricity for charging the vehicle battery, thus ensuring that the battery voltage can be maintained to be within a working voltage range. The electricity from the alternator is usually supplied to the vehicle battery through a number of silicon controlled rectifiers. However, because the alternator supplies electricity continuously to the vehicle battery, engine horsepower cannot be increased due to the need for the engine to drive the alternator continuously. In addition, long conducting periods of the silicon controlled rectifiers can lead to overheating, waste of power consumption, and unsatisfactory battery charging efficiency.

### SUMMARY OF THE INVENTION

Therefore, the object of the present invention is to provide a charging control device for vehicle use that can overcome the above drawbacks associated with the prior art.

According to the present invention, there is provided a charging control device adapted to be coupled between an alternator and a vehicle battery so as to control charging of the vehicle battery. The charging control device comprises a control unit and a switching circuit. The control unit has an input end adapted to be connected electrically to the vehicle battery for receiving a battery voltage signal therefrom, and an output end. The switching circuit includes at least two switch units, each of which is adapted to be connected electrically between the alternator and the vehicle battery and includes a conducting unit. The conducting unit includes a silicon controlled rectifier connected electrically to the output end of the control unit and adapted to be connected electrically to the alternator. The control unit controls the silicon controlled rectifier of the conducting unit of each of the switch units to switch from a non-conducting state to a conducting state with reference to the battery voltage signal from the vehicle battery such that each of the switch units permits supply of electricity from the alternator to the vehicle battery when the battery voltage signal is lower than a predetermined threshold, and such that each of the switch units interrupts supply of the electricity from the alternator to the vehicle battery when the battery voltage signal is not lower than the predetermined threshold.

### BRIEF DESCRIPTION OF THE DRAWING

Other features and advantages of the present invention will become apparent in the following detailed description of the preferred embodiment with reference to the accompanying drawing, of which:

FIG. 1 is an electrical circuit diagram of a preferred embodiment of a charging control device for vehicle use according to the present invention.

### DETAILED DESCRIPTION OF THE PREFERRED EMBODIMENT

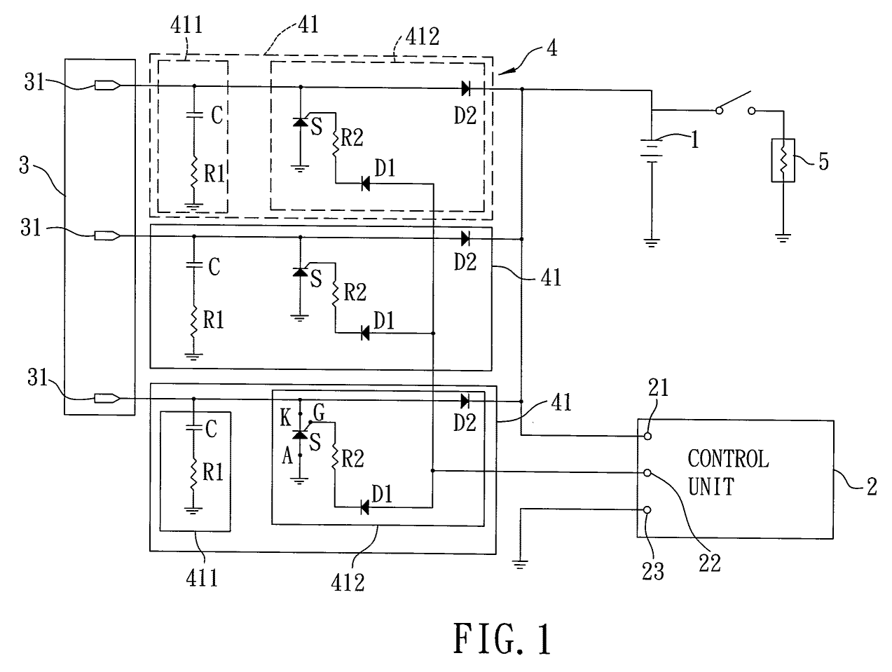

Referring to FIG. 1, the preferred embodiment of a charging control device for vehicle use according to the present invention is shown to be adapted to be coupled between an alternator 3 and a vehicle battery 1 so as to control charging of the vehicle battery 1. The vehicle battery 1 is used to supply electric power to a vehicle load 5, such as a headlight, a signal light, a horn, etc. The alternator 3 is a three-phase alternator and has three alternator terminals 31.

The charging control device includes a control unit 2 and a switching circuit 4. The control unit 2 has an input end 21 adapted to be connected electrically to the vehicle battery 1 for receiving a battery voltage signal therefrom, an output end 22, and a grounded end 23. The switching circuit 4 includes at least two switch units 41 (there are three switch units 41 in this embodiment), each of which is adapted to be connected electrically between the vehicle battery 1 and a respective one of the alternator terminals 31 of the alternator 3, and each of which includes a filtering and energy storing unit 411 and a conducting unit 412. In this embodiment, the filtering and energy storing unit 411 includes a series connection of an energy storing capacitor (C) and a resistor (R1) connected electrically between the respective alternator terminal 31 and ground. The conducting unit 412 includes a silicon controlled rectifier (S), a resistor (R2), and first and second diodes (D1, D2). The silicon controlled rectifier (S) has a cathode (K) connected electrically to the respective alternator terminal 31, a grounded anode (A), and a gate (G) connected electrically to one end of the resistor (R2). The first diode (D1) is connected electrically between the other end of the resistor (R2) and the output end 22 of the control unit 2. The second diode (D2) has an anode connected to the cathode (K) of the silicon controlled rectifier (S), and a cathode connected to a positive terminal of the vehicle battery 1.

The control unit 22 controls the silicon controlled rectifier (S) of the conducting unit 412 of each of the switch units 41 to switch from a non-conducting state to a conducting state with reference to the battery voltage signal from the vehicle battery 1. In particular, when a vehicle that incorporates the charging control device of this invention is actuated, the vehicle battery 1 will supply electric power to the vehicle load 5. At this time, the control unit 2 will detect the battery voltage of the vehicle battery 1 through the input end 21 and the ground end 23 thereof. Although the alternator 3 will generate electricity when the engine (not shown) of the vehicle is actuated, upon detection by the control unit 2 that the battery voltage signal from the vehicle battery 1 is lower than a predetermined threshold, i.e., battery power is insufficient, the control unit 2 will operate each of the switch units 41 to permit supply of the electricity from the alternator 3 to the vehicle battery 1. On the other hand, upon detection by the control unit 2 that the battery voltage signal from the vehicle battery 1 is not lower than the predetermined threshold, i.e., battery power is sufficient, the control unit 2 will operate each of the switch units 41 to interrupt supply of the electricity from the alternator 3 to the vehicle battery 1. The alternator 3 is in an idle load state at this time so as to reduce gasoline consumption and improve charging efficiency of the alternator 3 and engine horsepower performance.

In this invention, since electricity from the alternator 3 does not flow continuously through the silicon controlled rectifiers (S), overheating of the same can be avoided to improve operational stability and prolong the service life.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A charging control device adapted to be coupled between an alternator and a vehicle battery so as to control charging of the vehicle battery, said charging control device comprising:
a control unit having an input end adapted to be connected electrically to the vehicle battery for receiving a battery voltage signal therefrom, and an output end; and
a switching circuit including at least two switch units, each of which is adapted to be connected electrically between the alternator and the vehicle battery and includes a conducting unit, said conducting unit including a silicon controlled rectifier connected electrically to said output end of said control unit and adapted to be connected electrically to the alternator;
wherein said control unit controls said silicon controlled rectifier of said conducting unit of each of said switch units to switch from a non-conducting state to a conducting state with reference to the battery voltage signal from the vehicle battery such that each of said switch units permits supply of electricity from the alternator to the vehicle battery when the battery voltage signal is lower than a predetermined threshold, and such that each of said switch units interrupts supply of the electricity from the alternator to the vehicle battery when the battery voltage signal is not lower than the predetermined threshold.

2. The charging control device as claimed in claim 1, wherein said conducting unit of each of said switch units further includes a first diode interconnecting electrically a gate of said silicon controlled rectifier and said output end of said control unit, and a second diode connected electrically to a cathode of said silicon controlled rectifier and adapted to be connected electrically to the vehicle battery, said cathode of said silicon controlled rectifier being further adapted to be connected electrically to the alternator, said silicon controlled rectifier further having a grounded anode.

3. The charging control device as claimed in claim 2, wherein each of said switch units further includes a filtering and energy storing unit that includes a series connection of an energy storing capacitor and a resistor connected electrically between said cathode of said silicon controlled rectifier of said conducting unit and ground.
